(19) United States
(12) Patent Application Publication
(10) Pub. No.: US 2018/0076880 A1
(43) Pub. Date: Mar. 15, 2018

(54) INTERNET COMMUNICATION SYSTEMS FOR USE BY SPACE VEHICLES

(71) Applicant: Brian BARNETT, Albuquerque, NM (US)

(72) Inventor: Brian BARNETT, Albuquerque, NM (US)

(21) Appl. No.: 15/699,049

(22) Filed: Sep. 8, 2017

Related U.S. Application Data
(60) Provisional application No. 62/393,212, filed on Sep. 12, 2016.

(51) Int. Cl. H04B 7/185

(52) U.S. Cl. CPC H04B 7/18513; H04B 7/18515

(57) ABSTRACT

A space communication system has a payload adapted be carried by a space vehicle, a payload operations center having an earth-based location, a ground station, a first satellite, and a second satellite. The second satellite is positioned closer to the payload than the first satellite. The payload operations center transmits an internet message to the ground station. The ground station transmits the internet message to the first satellite. The first satellite transmits the internet message to the second satellite. The space communication system also includes a space vehicle having the payload carried therein.

### CROSS-REFERENCE TO RELATED APPLICATIONS

The present application claims priority from U.S. Provisional Patent Application Ser. No. 62/393,212, filed on Sep. 12, 2016, and entitled “Internet Communication Systems for Use by Space Vehicles”.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

### 1. Field of the Invention

The present invention relates to communications with orbital and suborbital vehicles. More particularly, the present invention relates to transmission systems and processes whereby an earth-based internet message or transmission can be delivered in a cost-effective manner to a payload onboard the space vehicle.

### 2. Description of Related Art Including Information Disclosed Under 37 CFR 1.97 and 37 CFR 1.98

Communications systems are widely used for communications between a space vehicle and the earth. Typically, these communication systems serve to transmit a voice message from the space vehicle to a ground station. In other circumstances, various data are transmitted to and from the space vehicle. In the past, however, there has been no system employed whereby internet communications, including voice, messaging, email and text data can be transmitted from a ground-based user to the space vehicle.

The International Space Station is a manned vehicle in orbit about the earth. Under such circumstances, it would be highly desirable for the person within the International Space Station to transmit messages to the control center and/or to individuals on the earth and vice-versa. Heretofore, such communications has proven to be quite difficult to achieve and requires complex system of transmission capabilities in order to achieve such transmissions.

In the past, various patents have issued relating to communications with orbital and suborbital vehicles. For example, an early patent was that of U.S. Pat. No. 5,271,582, issued on Dec. 21, 1993 to Perkins et al. This patent describes a multiple subsidiary small payloads that are connected to standard mechanical and electrical interfaces provided by an expandable or recoverable modular mother satellite bus and launched into space as an assembly acting as a common carrier. This system provides a variety of electrical, and thermal control services for payloads after reaching orbit. The services include items related to the controlled separation of pre-flying satellites or re-entry vehicles, regulated electrical power at a variety of voltages, telemetry computer-controlled, payload controlled via time-delayed pre-programmed instructions, real-time payload controlled via direct radio communication or transmission through geostationary or other communications satellite links, time-driven or event-driven control logic, mass data memory, encryption and decryption for the data and commands, and interconnection between subsidiary attached payloads through the data bus.

U.S. Pat. No. 6,175,783, issued on Jan. 16, 2001 to Strength et al., describes a payload control system and payload controller for outer space vehicle payloads. This system has a host computer system. The payload controller includes a unitary compact control unit mounted on a circuit board. The control unit includes a processor, memory, display device control logic, input device control logic, and data input/output control logic. A plurality of interfaces are located about the circuit board so as to provide communication with payload and host system components. A computer-readable storage medium is mounted on the circuit board to store information to control the payload when the payload is in outer space. The information stored in the computer-readable storage medium is non-permanent so that the payload controller may be re-used for different payload experiments.

U.S. Pat. No. 6,873,886, issued on Mar. 29, 2005 to Mullen et al., discloses an open system architecture and software system for plug-and-play modular mission payloads in aerial vehicles. The software moves the control function of mission payloads away from the ground station and into the aerial vehicle. The plug-and-play web-based payload interface software resides in a payload interface controller in the vehicle. This is networked via a uniform resource locator address to a ground control station.

U.S. Pat. No. 7,505,736, issued on Mar. 17, 2009 to B. K. Min, shows a method and system for a plurality of airplanes in flight to receive from and to send to a plurality of ground stations broadcasting communication signals through a single or a plurality of geostationary satellites. There is a mobile link between the airplanes and the satellite. This link uses the high frequency radio waves at 17 GHz or higher, such as the Ka-band. The fixed link between the satellite and the ground stations can use any radio frequencies below the frequencies used to communicate between the satellite and the aircraft. Frequencies such as C-band or Ku-band, or Ka-band are applied between satellites and ground such that the available link margin is sufficient to overcome rain attenuation at the ground stations. The satellite carries a plurality of transponders that may include a plurality of frequency converters to enable the conversion between different frequencies. The satellite generates a plurality of spot beams, shaped or unshaped, which collectively cover the flight routes of the airplanes.

U.S. Pat. No. 8,594,662, issued on Nov. 26, 2013 to P. J. Hadinger, shows a method and apparatus for protecting communication to high-altitude aircraft. A signal is transmitted from the aircraft to the spacecraft having a frequency in the range of 50 to 70 GHz. The frequency of the signal is selected based on the altitude of the aircraft and the elevation angle between the spacecraft and the aircraft.

It is an object of the present invention to provide a system wherein texting, email and general Internet messages can be delivered to a payload in space from the ground.

It is another object of the present invention to provide a communication system wherein the Internet transmissions can be delivered to a location above 100 kilometers above the earth.

It is another object of the present invention to provide a communication system whereby the internet transmissions can be delivered to vehicles having a speed above that of rocket velocities.

It is another object of the present invention to provide a communication system that enables two-way communications between a ground location and the space vehicle.

It is another object of the present invention to provide a communications system that enhances the abilities of commercial space companies.

It is another object of the present invention to provide a communication system that is cost-effective.

It is still another object of the present invention to provide a communication system that provides high-speed secure internet service to the space vehicle.

These and other objects and advantages of the present invention will become apparent from a reading of the attached specification and appended claims.

### BRIEF SUMMARY OF THE INVENTION

The present invention is a communications system that comprises a payload that is adapted to be carried by a space vehicle, a payload operations center on an earth-based location, a ground station, a first satellite and a second satellite. The payload operations center can transmit an internet message to the ground station. The ground station transmits the message to the first satellite. The first satellite can then transmit the internet message to a second satellite that is closest to the payload.

In the system of the present invention, the payload is carried by the space vehicle. The term “space vehicle” can include the International Space Station, orbital vehicles and sub-orbital vehicles, commercial space stations, cubesats, and other platforms in space. The space vehicle has an antenna thereon. The antenna can include a GPS antenna. Additionally, this antenna can have a wraparound antenna configuration. A logistics carrier is mounted to the space vehicle. The payload communicator is mounted on the logistics carrier.

The payload operations center can include a payload operator desktop or a payload operator mobile device. In particular, the desktop or mobile device can transmit an internet message or receive an internet message. Essentially, this means that any person having internet capability and transmission capability is able to send an internet message to a space vehicle. The ground station is adapted to receive the internet message from the desktop or mobile device. As such, transmission occurs between the desktop or the mobile device so as to be received from the ground station. The ground station can also be utilized so as to return a message from the space vehicle back to the desktop and/or the mobile device. The first satellite is a low earth orbit satellite. The ground station will transmit the internet message to the first satellite and receive signals from the first satellite. The second satellite is a satellite that is located closest to the space vehicle. In particular, the second satellite can be a cubesat having a payload communicator thereon. Alternatively, transmissions can made directly from the first satellite to the space vehicle.

In the process of the present invention includes the following steps: (1) sending an internet message from a payload operations center; (2) receiving the sent internet message at a ground station; (3) beaming the received internet message to a first satellite; (4) relaying the beamed internet message from the first satellite to a second satellite; and (5) delivering the relayed message from the second satellite to a payload communicator of a space vehicle.

The method of the present invention, the payload communicator is installed onto the space vehicle and then the space vehicle is launched. The space vehicle is then placed into orbit.

The method of the present invention can further include transmitting an internet message from the payload on the space vehicle to the second satellite, relaying the internet message from the second satellite to the first satellite, beaming the internet message from the first satellite back to the ground station, and transmitting the internet message from the ground station to the payload operations center. Along with this message, a payload position report is provided.

As used herein, the term “internet message” can include data, messages, voice, and other internet-provided functions. The internet message can be provided along the internet to the ground station. As such, no new equipment is required in order to deliver the internet message to the ground station.

This foregoing Section is intended to describe, with particularity, the preferred embodiments of the present invention. It is understood that modifications to these preferred embodiments can be made within the scope of the appended claims. As such, this Section should not to be construed, in any way, as limiting of the scope of the present invention. The present invention should only be limited by the following claims and their legal equivalents.

### BRIEF DESCRIPTION OF THE SEVERAL VIEWS OF THE DRAWINGS

FIG. 1 a block diagram showing the system and process of the present invention.

### DETAILED DESCRIPTION OF THE INVENTION

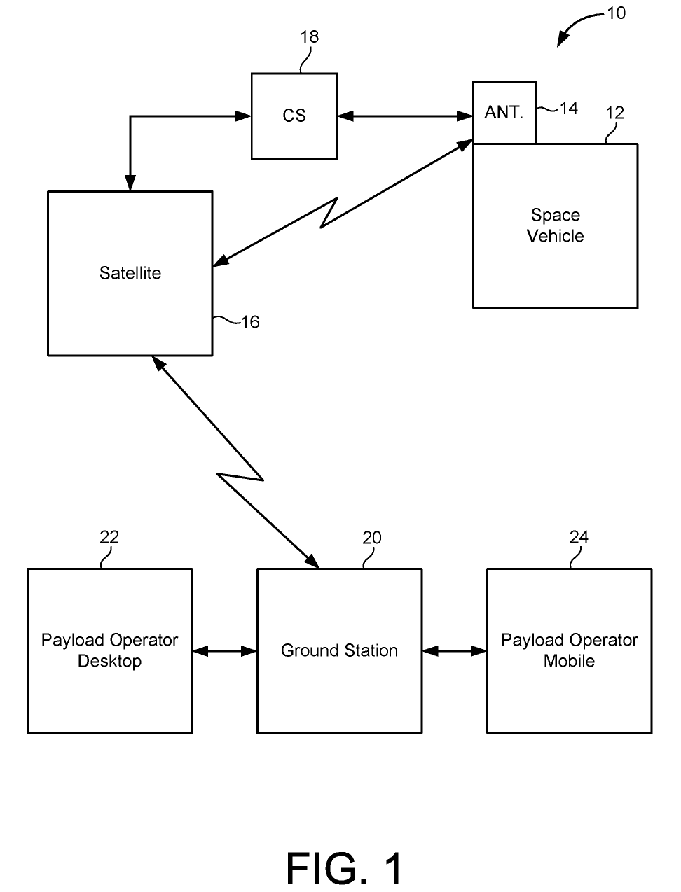

Referring to FIG. 1, there is shown the system 10 for delivering internet messages to a space vehicle 12. FIG. 1 shows that the space vehicle 12 has an antenna 14 mounted on an exterior thereof. A satellite 16 is provided in low earth orbit. A cubesat 18 can be positioned to relay messages from the satellite 16 to the antenna 14 of the space vehicle. The cubesat 18 can also be the space vehicle 12 and operate autonomously. The first satellite 16 is interactive with a ground station 20. The ground station can be, in particular, an Iridium ground station currently in existence. The ground station 20 can be interactive with a payload operator desktop 22 and/or a payload operator mobile device 24. Each of the payload operator desktop 22 and the payload operator mobile 24 use conventional internet transmission capabilities for delivering an internet message to the ground station 18.

The space vehicle 12 can be any type of space vehicle, orbital or suborbital. The space vehicle 12 can also be the International Space Station, private or commercial platforms, or cubesats. The payload communicator can be positioned within the space vehicle 12 so as to provide audio or visual interaction with the operator of the space vehicle or other payloads within the space vehicle. The antenna 14 can include a GPS antenna, a wraparound antenna configuration, a ratch antenna or similar items. The payload communicator can connect to other payloads within the space vehicle 12 that require two-way connectivity. The payload communicator within the space vehicle 12 provides voice and data capabilities.

In operation, the payload operator desktop 22 or the payload operator mobile 24 will send an internet message to the ground station 20. For example, an operator at the desktop 22 can type a message and send the message to the ground station 20. The ground station 20 will then beam the received message from the desktop 22 or mobile device 24 to the first satellite 16. The satellite 16 can then relay the message to the cubesats 18 (or other satellite). The second satellite 18 can then deliver the message to the antenna 14 on the space vehicle 12.

The cubesat 18 is a type of miniaturized satellite for space research that is made up of multiples of cubic units. Cubesats are most commonly put into orbits by deployers on the International Space Station or as secondary payloads on a launch vehicle. Many cubesats are used to demonstrate spacecraft technologies that are targeted for use in small satellites. Cubesats are launched by universities, states, private companies, or other government agenies. The main reason for miniaturizing satellites is to reduce the cost of deployment. Cubesats are often suitable for launch in multiples by using the excess capacity of larger launch vehicles. The cubesats are designed specifically to minimize the risk to the rest of the launch vehicle and payloads. As such, the cubesat 18 is the preferred form of the second satellite 18 that can be deployed from the space station so that communications can be delivered to the antenna 14 of the space vehicle 12, or the cubesat can operate autonomously.

Alternatively, in the present invention, if the first satellite 16 is in sufficient proximity to the antenna 14 of the space vehicle 12, the internet message can be delivered directly from the first satellite to the space vehicle 12.

In the configuration described hereinbefore, a person on the International Space Station or a payload within a space vehicle can receive the internet message from the desktop 22 or mobile device 24. This message can be manipulated and processed so as to control devices within the space vehicle or to receive data reports from the space vehicle. In this manner, the internet can be utilized so as to interrogate items within the space vehicle 12.

The space vehicle 12 can then return an internet message back to an earth-based location. The antenna 14 will transmit the internet message to the second satellite 18. Second satellite 18 then relays this message to the first satellite 16. The first satellite 16 can then beam this internet message to the ground station 20. The ground station can then deliver this message to the desktop 22 and/or mobile device 24 using standard internet transmission technologies.

The antenna 14 and the payload communicator within the space vehicle 12 are essentially space-segment data relay terminals. The relay terminal can be mounted externally on the International Space Station so as to provide an innovative new communications channel using commercial, mobile satellite services. This system provides high-speed, secure, commercial internet service that is available to International Space Station tenants including NASA, commercial, governmental, research, and international customers and their payloads. Specifically, for the International Space Station, this onboard capability to provide additional of uplink/downlink capability to supplement current Ku-band and S-band communications and communications for a Wi-Fi enabled payload within the Wi-fi range. Ultimately, the system can be applied to many other low earth orbit (and perhaps middle earth orbit and geosynchronous) missions beyond the International Space Station. This invention provides an innovative approach to commercial communications on the International Space Station.

The present invention provides internet-accessible flight-to-ground communications for payload users. In particular, these payload users can include the International Space Station, International Space Station core systems users, and other non-international space station pre-flying low earth orbit missions. The system includes a satellite internet terminal that is connected to a International Space Station payload with on-orbit commercial mobile satellite services.

Commercial communication services for the International Space Station supplement existing Ku-band and S-band communications. The system can benefit payload users and can also benefit core systems operators. Free-flying cameras taking imagery of a defective Ku-band antenna can be used when the main communication link is down. The present system can provide communication services for free-flying NASA science satellites in low earth orbit. The system of the present invention can include delay/disruption tolerant networking capabilities to support NASA's long-range solar system internet. The present invention further provides direct two-way communications between the Huntsville Operations Support Center and the International Space Station payloads.

Commercial users on the International Space Station can establish their own downlink so as to avoid capacity conflicts with an oversubscribed downlink. Commercial spacecraft in the range of the International Space Station Wi-Fi signal can also be utilized in the present invention. The system of the present invention can also be used on internet-based communication services on-board commercial orbiting and suborbiting spacecraft. The system of the present invention is applicable to non-NASA governmental agencies, military and security agencies, academia and international payloads on the International Space Station, or other space-based platforms.

The foregoing disclosure and description of the invention is illustrative and explanatory thereof. Various changes in the details of the illustrated construction and steps of the described method can be made within the scope of the present claims without departing from the true spirit of the invention. The present invention should only be limited by the following claims and their legal equivalents.

I claim:

1. A space communication system comprising:
a payload adapted to be carried by space vehicle;
a payload operations center having an earth-based location;
a ground station;
a first satellite; and
a second satellite positioned closer to said payload than said first satellite, said payload operations center transmitting an internet message to said ground station, said ground station transmitting the internet message to said first satellite, said first satellite transmitting the internet message to said second satellite.

2. The space communications system of claim 1, further comprising:
a space vehicle having said payload carried therein.

3. The space communication system of claim 2, said space vehicle selected from the group consisting of the International Space Station, orbital vehicles, sub-orbital vehicles, commercial space stations and cubesats.

4. The space communication system of claim 2, said space vehicle having an antenna thereon.

5. The space munication system of claim 4, said antenna selected from the group consisting of a GPS antenna, a wraparound antenna and combinations thereof.

6. The space munication system of claim 2, said space vehicle having a logistics carrier mounted thereto, said logistics carrier having a payload communicator.

7. The space communication system of claim 1, said payload operations center being a payload operator desktop.

8. The space communication system of claim 1, said payload operations center being a payload operator mobile device.

9. The space communication system of claim 1, said payload operations center transmitting and receiving the internet message.

10. The space communication system of claim 2, said ground station receiving the internet message from the payload operations center.

11. The space communication system of claim 10, said ground station passing the internet message from the space vehicle to said payload operations center.

12. The space communication system of claim 1, said first satellite being a low earth orbit satellite.

13. The space communication system of claim 1, said second satellite being a cubesat having a payload communicator thereon.

14. A process for communicating an internet message to a space station, the process comprising:
sending the internet message from a payload operations center;
receiving the sent internet message at a ground station;
beaming the received internet message to a first satellite;
relaying the beamed internet message from the first satellite to a second satellite; and
delivering the relayed message from the second satellite to a payload communicator of a space vehicle.

15. The process of claim 14, further comprising:
installing the payload communicator onto or into the space vehicle;
launching the space vehicle; and
placing the space vehicle in orbit.

16. The process of claim 14, further comprising:
transmitting the internet message from the payload communicator to the second satellite;
relaying the internet message from the second satellite to the first satellite;
beaming the internet message from the first satellite to the ground station; and
transmitting the internet message from the ground station to the payload operation center.

17. The process of claim 16, further comprising:
providing a payload position report to the payload operations center.

18. The process of claim 14, further comprising:
transmitting the internet message to the ground station from another earth-based device.

19. The process of claim 14, the internet message selected from the group consisting a data message, a voice message, a text message, and combinations thereof.

20. A communication system for use by a space vehicle comprising:
a payload adapted to be carried by the space vehicle;
a payload operations center located at an earth-based location;
a ground station cooperative with said payload operations center so as to receive and transmit messages from and to said payloads operations center; and
a first satellite that can receive internet messages from said ground station, said first satellite transmitting messages to said payload.
